(19) United States
(12) Patent Application Publication
(10) Pub. No.: US 2026/0006042 A1
(43) Pub. Date: Jan. 1, 2026

(54) CYBER ATTACK RECONNAISSANCE DETECTION AND PREVENTION

(71) Applicant: Dell Products L.P., Round Rock, TX (US)

(72) Inventors: Parminder Singh Sethi, Ludhiana (IN); Anay Kishore, Bangalore (IN); Praveen Kumar, Noida (IN)

(21) Appl. No.: 18/756,588

(22) Filed: Jun. 27, 2024

(51) Int. Cl. H04L 9/40

(52) U.S. Cl. CPC H04L 63/1416; H04L 63/02

(57) ABSTRACT

A method comprises receiving one or more requests for data, wherein the one or more requests are received over at least one computer network, analyzing at least one of the one or more requests and one or more processes performed in response to the one or more requests to determine whether the one or more requests comprise reconnaissance for a cyber attack, and preventing at least one of generation and transmission of one or more responses to the one or more requests in response to determining that the one or more requests comprise the reconnaissance for the cyber attack.

### FIELD

The field relates generally to information processing systems, and more particularly to security management in such information processing systems.

### BACKGROUND

The risk of cyber attacks is increasing as new attack methods and new system vulnerabilities are being discovered. To be able to successfully attack a datacenter or other computing platform, attackers may spend a considerable amount of time planning and gathering information from a target system. This process is known as reconnaissance. Since most reconnaissance activities can be subtly performed as smaller tasks, they may be difficult to detect and understand. With little or no knowledge about reconnaissance activities, critical data and services remain vulnerable to attack.

### SUMMARY

Embodiments provide techniques for detection and prevention of reconnaissance for cyber attacks.

For example, in one embodiment, a method comprises receiving one or more requests for data, wherein the one or more requests are received over at least one computer network, analyzing at least one of the one or more requests and one or more processes performed in response to the one or more requests to determine whether the one or more requests comprise reconnaissance for a cyber attack, and preventing at least one of generation and transmission of one or more responses to the one or more requests in response to determining that the one or more requests comprise the reconnaissance for the cyber attack.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a datacenter including an edge monitoring module configured to detect and prevent cyber attack reconnaissance in an illustrative embodiment.

FIG. 2 depicts an operational flow for validation of network requests and of request processing in an illustrative embodiment.

FIG. 3 depicts an operational flow for machine learning using a fuzz testing mechanism in an illustrative embodiment.

FIG. 4 depicts a block diagram of components of an edge monitoring module configured to detect and prevent cyber attack reconnaissance in an illustrative embodiment.

FIG. 5 depicts an architecture including multiple datacenters and corresponding edge monitoring modules configured to detect and prevent cyber attack reconnaissance in an illustrative embodiment.

FIG. 6 depicts a block diagram of components of a content delivery network (CDN) aggregator in an illustrative embodiment.

FIG. 7 depicts a block diagram of components of a backend server in an illustrative embodiment.

FIG. 8 depicts an architecture including multiple edge monitoring modules connected to a backend server through respective content delivery network (CDN) aggregators in an illustrative embodiment.

FIG. 9 depicts a process for detection and prevention of cyber attack reconnaissance according to an illustrative embodiment.

FIGS. 10 and 11 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous, and a user device receives messages without any significant time delay. Of course, it should be understood that depending on the particular temporal nature of the system in which an embodiment is implemented, other appropriate timescales that provide at least contemporaneous performance and output can be achieved.

As used herein, “application programming interface (API)” or “interface” refers to a set of subroutine definitions, protocols, and/or tools for building software. Generally, an API defines communication between software components. APIs permit programmers to write software applications consistent with an operating environment or website. APIs are used to integrate and pass data between applications, and may be implemented on top of other systems.

As used herein, a “cyber attack” refers to a malicious and deliberate attempt to breach an information system. Some non-limiting examples of cyber attacks include malware (e.g., malicious software, including spyware, ransomware, viruses, worms, etc.), phishing, eavesdropping attacks, denial-of-service (DoS) attacks, distributed DoS (DDoS) attacks, structured query language (SQL) injections, zero-day exploits, domain name system (DNS) tunneling, etc.

As used herein, “reconnaissance” refers to the process of gathering information about a target system and/or organization before launching a cyber attack. Reconnaissance can include, for example, the systematic surveying and/or scanning of systems, networks, ports or web applications to gather information about potential vulnerabilities that can be exploited. Other reconnaissance activities may include, for example, identifying the Internet Protocol (IP) addresses associated with a target, mapping out a network structure of the target, identifying firewalls, intrusion detection systems or other security measures, locating open ports and other access points, and determining services running on ports and other access points.

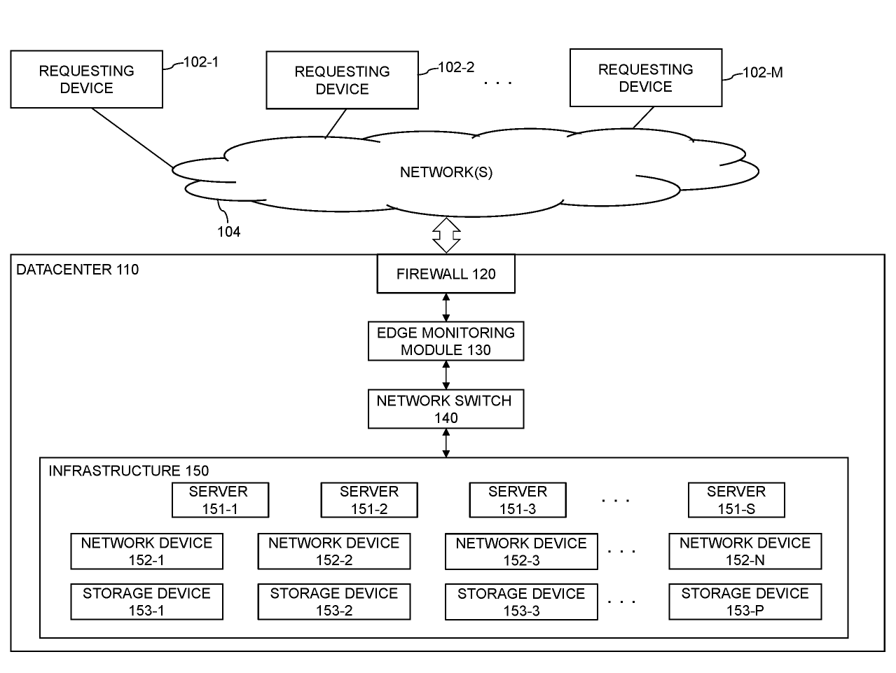

FIG. 1 shows an information processing system 100 configured in accordance with an illustrative embodiment. The information processing system 100 comprises requesting devices 102-1, 102-2, . . . 102-M (collectively “requesting devices 102”). The requesting devices 102 communicate over a network 104 with a datacenter 110. The variable M and other similar index variables herein such as K, L, N, P, S and X are assumed to be arbitrary positive integers greater than or equal to one.

The requesting devices 102 can comprise, for example, Internet of Things (IoT) devices, desktop, laptop or tablet computers, mobile telephones, or other types of processing devices capable of communicating with the datacenter 110 over the network 104. Such devices are examples of what are more generally referred to herein as “processing devices.” Some of these processing devices are also generally referred to herein as “computers.” The requesting devices 102 may also or alternately comprise virtualized computing resources, such as virtual machines (VMs), containers, etc. The requesting devices 102 in some embodiments comprise respective computers associated with a particular company, organization or other enterprise. In illustrative embodiments, the requesting devices 102 execute client-side applications used for connecting to the datacenter 110 and one or more servers 151-1, 151-2, 151-3, . . . 151-S (collectively “servers 151”) of the datacenter 110 over the network 104. A non-limiting example of a client-side application is a web browser or web application which, for example, displays web pages received from the servers 151 and allows users to interact with the servers 151.

In some cases, the requesting devices 102 do not serve a legitimate purpose, and are devices used to perform malicious applications, such as, for example, to perform reconnaissance for cyber attacks, or to execute the cyber attacks themselves.

The terms “user” or “client” herein are intended to be broadly construed so as to encompass numerous arrangements of human, hardware, software or firmware entities, as well as combinations of such entities. Reconnaissance detection and prevention services may be provided utilizing one or more machine learning models, although it is to be appreciated that other types of infrastructure arrangements could be used. At least a portion of the available services and functionalities provided by the datacenter 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the datacenter 110, as well as to support communication between the datacenter 110 and connected devices (e.g., requesting devices 102) and/or other related systems and devices not explicitly shown.

Reconnaissance refers to activities that collect critical system information that may be used during a cyber attack. The critical system information may include data related to certain vulnerabilities of the system (e.g., DNS vulnerabilities, dynamic host configuration protocol (DHCP) vulnerabilities, proxy vulnerabilities, port vulnerabilities, firewall vulnerabilities, simple mail transfer protocol (SMTP) vulnerabilities, active directory vulnerabilities, domain controller vulnerabilities, etc.). Recently, there has been a surge in cyber attacks, and reconnaissance plays a vital role in facilitating such attacks.

Current approaches fail to detect malicious reconnaissance calls and activities. In addition, with conventional techniques, the large volume of network operations within a datacenter are not sufficiently tracked or managed to prevent information gathering from reconnaissance activities. In addition, there are no mechanisms in place to learn the circumstances to identify and counter reconnaissance processes.

In an attempt to address the above technical problems, the illustrative embodiments advantageously provide an edge monitoring module in a datacenter configured to analyze incoming requests for application execution and the processes performed in response to the requests to determine whether the requests comprise reconnaissance for a cyber attack. As an additional advantage, the illustrative embodiments block transmission of responses to requests that have been determined to comprise reconnaissance.

Advantageously, the illustrative embodiments also use machine learning to learn normal processing patterns for various types of requests from historical data retrieved from existing applications and services. The embodiments store the learned processing patterns in a knowledge lake, and use the normal processing patterns to identify deviations from the normal patterns that would indicate requests which are attempts at reconnaissance.

The illustrative embodiments provide an automated framework for proactively and continuously scanning a system and its network to detect reconnaissance activities without hampering the system’s underlying performance. The embodiments further provide a mechanism to flag sources of malicious requests to prevent a system from processing requests from the flagged sources. As an additional advantage, the embodiments leverage edge computing configurations, where edge monitoring modules configured to configured to analyze incoming requests for application execution and the processes performed in response to the requests are locally deployed in datacenters and connected to a content delivery network (CDN) aggregator which, in turn, connects to a backend server over a network.

Referring back to FIG. 1, the datacenter 110 in the present embodiment is assumed to be accessible to the requesting devices 102 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols. The networks may comprise Internet Protocol version 6 (IPv6) and Internet Protocol version 4 (IPv4) configured networks. As explained in more detail herein, edge monitoring modules are configured to be generic with respect to IP protocol to work with IPv4 and IPv6. For example, edge monitoring modules can perform the verifying and other functions regardless of whether the applications are ported from IPv4 to IPv6 or vice-versa.

Some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the datacenter 110 includes a firewall 120, an edge monitoring module 130, a network switch 140, and an infrastructure 150. The infrastructure 150 comprises a plurality of servers 151, a plurality of network devices 152-1, 152-2, 152-3, . . . , 152-N (collectively “network devices 152”) and a plurality of storage devices 153-1, 153-2, 153-3, . . . , 152-P (collectively “storage devices 153”). The edge monitoring module 130 is connected between the firewall 120 and the network switch 140. The firewall 120 provides a level of network security for the datacenter 110 to and from an external network by monitoring incoming and outgoing network traffic. The firewall 120 determines whether to allow or block specific traffic based on a defined set of security rules. The firewall 120 functions as a barrier between trusted, secured and controlled internal networks and untrusted outside networks. The firewall 120 can comprise, for example, hardware and/or software.

The network switch 140 determines where (e.g., which one of the servers 151) to send incoming message frames based on, for example, media access control (MAC) address. In some embodiments, the network switch 140 maintains tables that match each MAC address to a corresponding port receiving the MAC address. In illustrative embodiments, the network switch 140 operates on the data-link layer, or Layer 2, of the Open Systems Interconnection (OSI) model. The network switch 140 can be a hardware device, software-based virtual device or combination thereof.

The network switch 140 is connected to the infrastructure 150. The infrastructure 150 includes network devices 152. The network devices 152 include, for example, ports, routers, buses, host bus arrays (HBAs), fabrics, bridges, hubs, gateways, network interface cards (NICs), modems, repeaters, wireless access points, etc. The infrastructure 150 comprises software configured to provide high-speed shared storage for elements (e.g., edge monitoring module 130, servers 151, etc.) of the datacenter 110. The infrastructure 150 includes storage devices 153. The storage devices 153 comprise one or more of various types of storage devices such as hard-disk drives (HDDs), solid-state drives (SSDs), flash memory cards, or other types of non-volatile memory (NVM) devices including, but not limited to, non-volatile random-access memory (NVRAM), phase-change RAM (PC-RAM), magnetic RAM (MRAM), etc. In some embodiments, the storage devices comprise flash memory devices such as NAND flash memory, NOR flash memory, etc. The NAND flash memory can include single-level cell (SLC) devices, multi-level cell (MLC) devices, triple-level cell (TLC) devices, or quad-level cell (QLC) devices. These and various combinations of multiple different types of storage devices 153 may be implemented in the infrastructure 150. In this regard, the term “storage device” as used herein should be broadly construed to encompass all types of persistent storage media including hybrid drives.

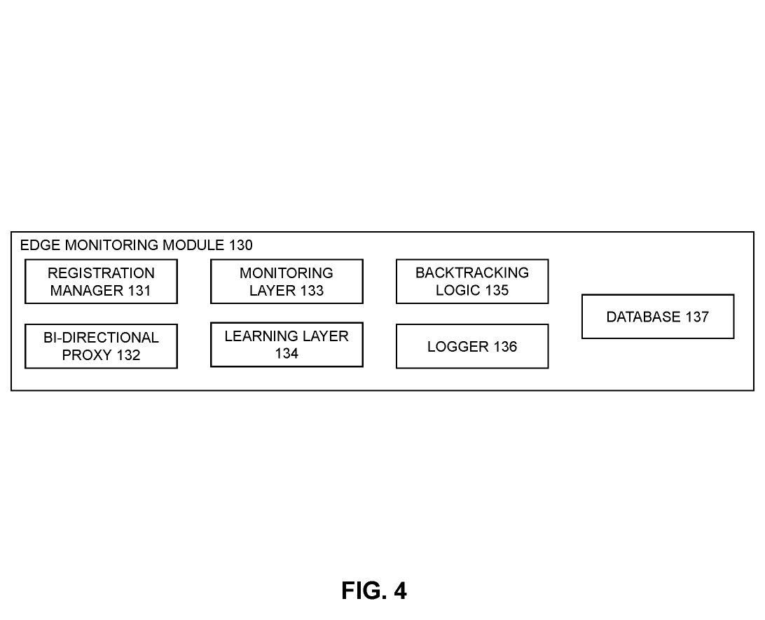

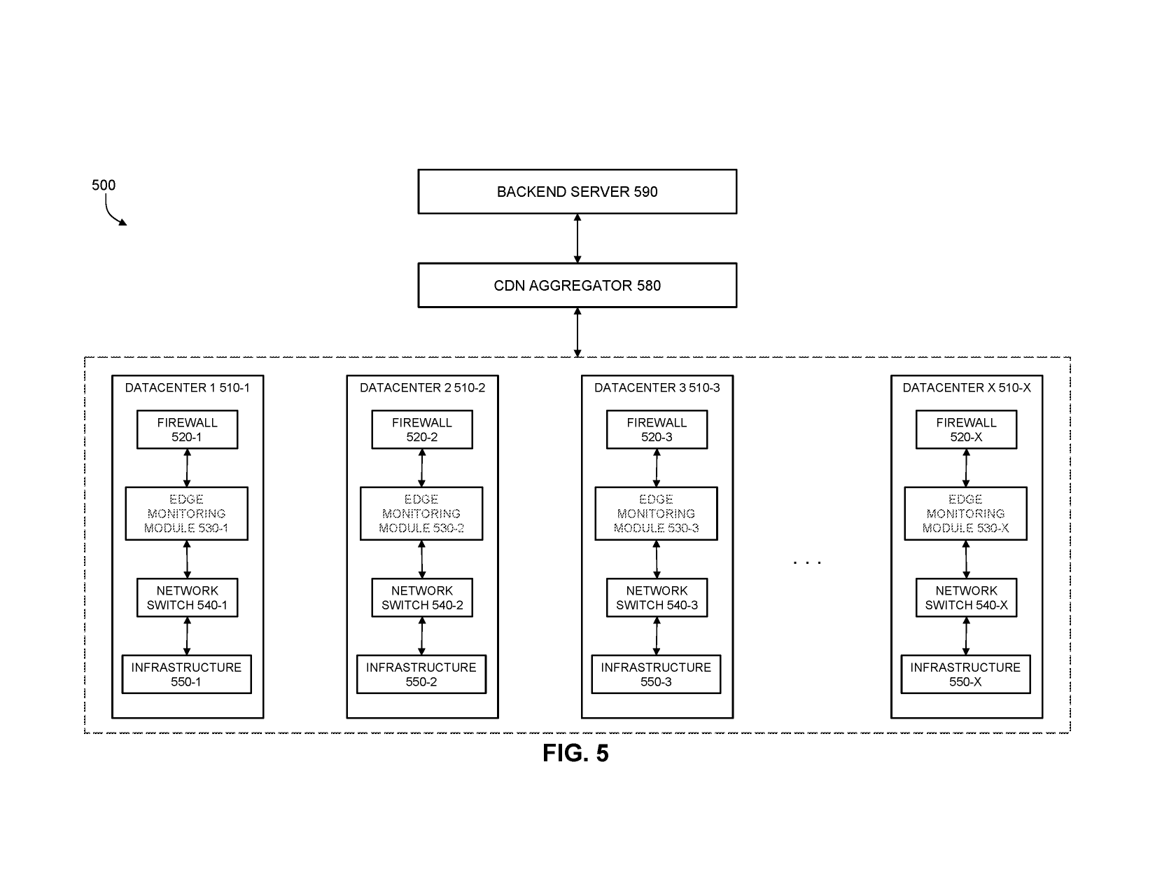

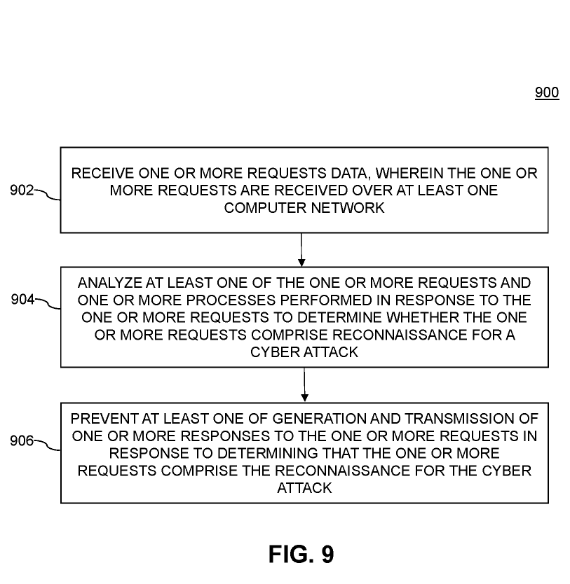

Referring to FIGS. 1 and 4, the edge monitoring module 130 comprises a registration manager 131, a bi-directional proxy layer 132, a monitoring layer 133, a learning layer 134, backtracking logic 135, a logger 136 and a database 137. The edge monitoring module 130 is located in the datacenter 110 and, in illustrative embodiments, is configured to monitor datacenter web services with designated parameters and filter inbound and outbound traffic. The edge monitoring module 130 works as an edge computing client sitting near the servers 151 where web applications and/or other applications are deployed. As explained in more detail in connection with FIGS. 5 and 8, clusters of edge monitoring modules are connected with respective CDN aggregators, which will be deployed on a zone basis based on the volume of required validation and support.

In illustrative embodiments, the edge monitoring module 130 is deployed in the datacenter 110 (e.g., customer datacenter) on a standalone machine with an operating system (OS) architecture such as, but not necessarily limited to, Windows, Linux, custom, Docker, etc. In some embodiments, the OS may be based on OS wrapper packaging by an administrator and/or root level user. Referring, for example, to the architecture 500 in FIG. 5, respective ones of a plurality of edge monitoring modules 530-1, 530-2, 530-3, . . . , 530-X (collectively “edge monitoring modules 530”) are deployed on respective ones of a plurality of datacenters 510-1, 510-2, 510-3, . . . , 510-X (collectively “datacenters 510”). Each edge monitoring module 530 is deployed between a corresponding one of a plurality of firewalls 520-1, 520-2, 520-3, . . . , 520-X (collectively “firewalls 520”) and a corresponding network switch of a plurality of network switches 540-1, 540-2, 540-3, . . . , 540-X (collectively “network switches 540”). The respective network switches 540-1, 540-2, 540-3, . . . , 540-X are connected to a plurality of infrastructures 550-1, 550-2, 550-3, . . . , 550-X (collectively “infrastructures 550”). The datacenters 510, firewalls 520, edge monitoring modules 530, network switches 540 and infrastructures 550 are the same as or similar to the datacenter 110, firewall 120, edge monitoring module 130, network switch 140 and infrastructure 150. FIG. 8 also illustrates an architecture 800 with multiple edge monitoring (EM) modules 830, which are the same as or similar to the edge monitoring modules 130/530.

The edge monitoring modules 130/530/830 include several features to enable the edge monitoring modules 130/530/830 to monitor and process network operations. In illustrative embodiments, the edge monitoring modules 130/530/830 validate network operations and transactions based on set criteria and parameters provided by a backend server (e.g., backend server 590/890 in FIGS. 5 and 8). As explained in more detail herein, the bi-directional proxy layer 132 uses a designated set of parameters and functions as a security hop for different requests coming into the datacenter 110 and for responses being output from the datacenter 110 to calling endpoints (e.g., requesting devices 102). The bi-directional proxy layer 132 adds an extra layer of security for applications and services that may be vulnerable to reconnaissance activity.

As can be understood from FIGS. 5 and 8, the number of monitored devices and services can be very large, and it may not be practical for one backend server to directly cater to each datacenter. In an edge computing configuration, edge monitoring modules 130/530/830 are respectively deployed in datacenters and subsets of datacenters (e.g., datacenters 110 and 510) are connected to respective CDN aggregators based on, for example, region, and are locally available to the corresponding edge monitoring modules 130/530/830 in their respective datacenters as first points of contact. For example, FIG. 5 shows datacenters 510 connected to a CDN aggregator 580, which, in turn, is connected to a backend server 590. FIG. 8 shows respective groups of EM modules 830 (each EM module 830 corresponding to a datacenter (not shown)) connected to respective CDN aggregators 880-1, 880-2 and 880-3 (collectively “CDN aggregators 880”), which are, in turn, connected to a backend server 890. The assignments of datacenters 510 and EM modules 830 to a CDN aggregator 580 or 880 can be based on, for example, geographic region (e.g., city, country, continent, etc.).

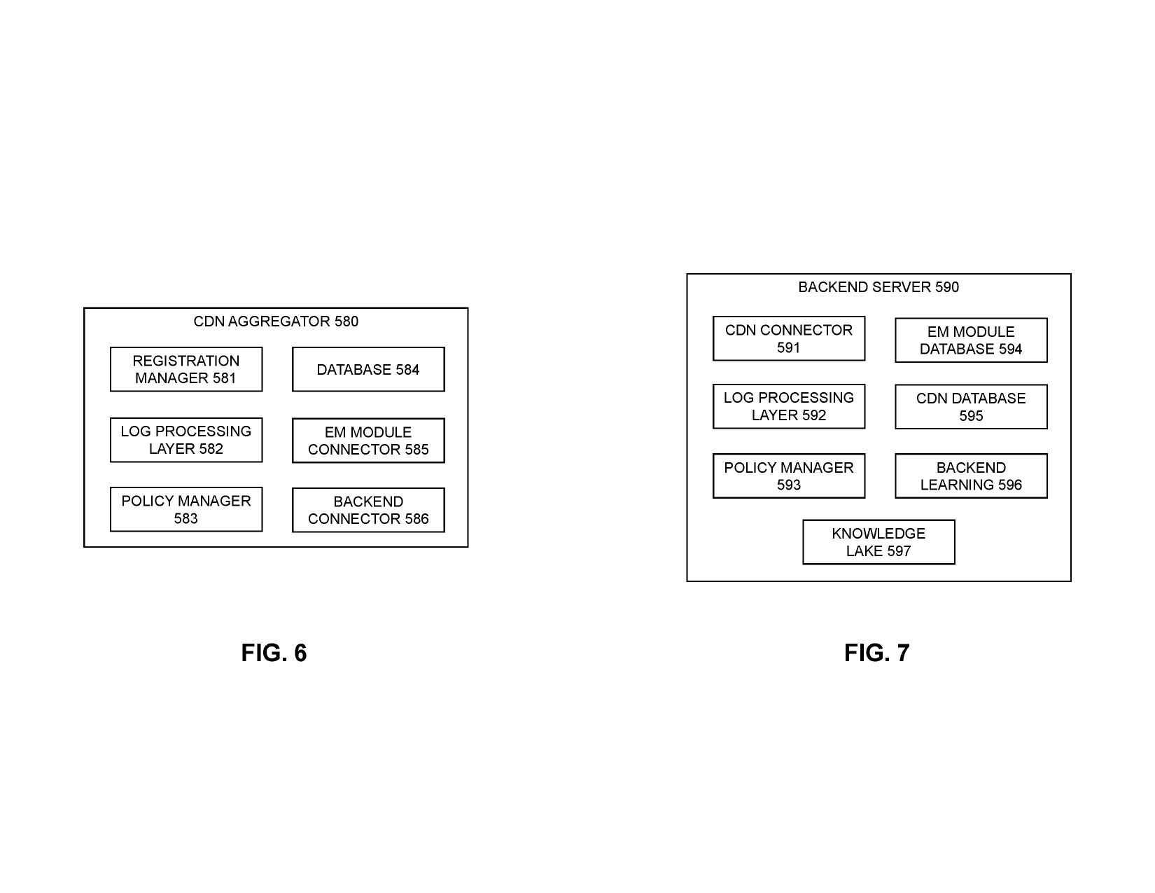

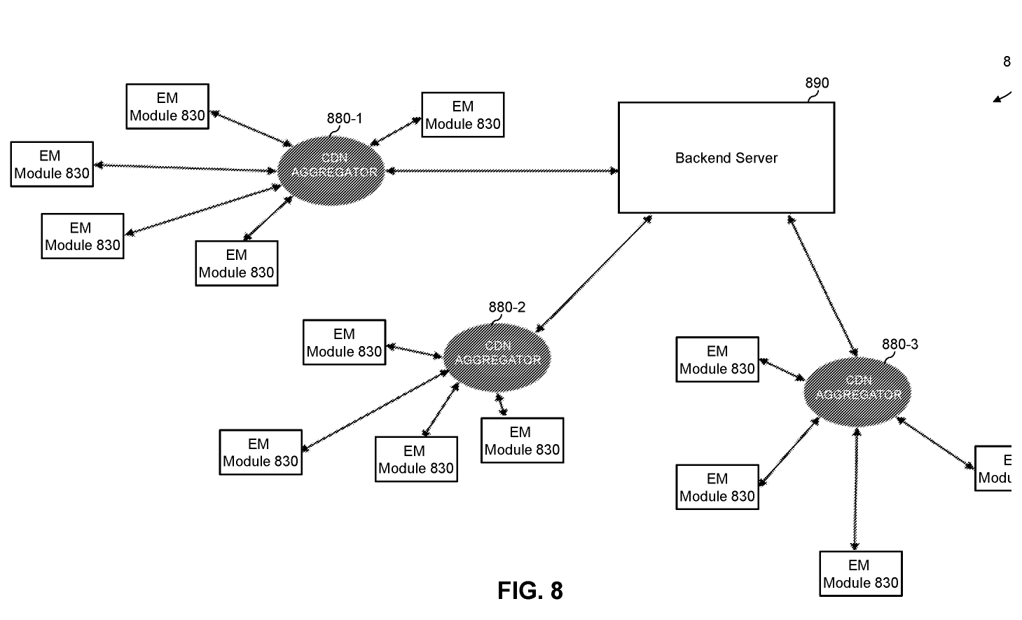

As explained in more detail herein, referring, for example, to FIGS. 6 and 7, the CDN aggregator 580 includes a registration manager 581, a log processing layer 582, a policy manager 583, a database 584, an EM module connector 585 and a backend connector 586. The registration manager 581 provides registration support to all the edge monitoring modules 130/530/830 in proximity to the CDN aggregator 580/880 (e.g., in a designated region, zone or area near the CDN aggregator 580/880). The registration manager 581 sends the details of each registration to the backend server 590/890. The log processing layer 582 receives and process different types of operational data (e.g., noted abnormalities, deviations, issues, logs and/or performance metric data) from the edge monitoring modules 130/530/830 via the EM module connector 585, and stores the received and processed operational data in the database 584. The EM module connector 585 implements one or more APIs to interface with an edge monitoring module 130/530/830. The received different types of operational data can further be uploaded to the backend server 590/890 for additional processing.

The backend server 590 includes a CDN connector 591, a log processing layer 592, a policy manager 593, an EM module database 594, a CDN database 595, a backend learning layer 596 and a knowledge lake 597. The CDN aggregators 880 may be the same as or similar to the CDN aggregator 580 and the backend server 890 may be the same as or similar to the backend server 590. In accordance with illustrative embodiments, the backend server 590/890 monitors support activities globally, where such monitoring is facilitated by the CDN aggregators 580/880. The backend server 590/890, via the CDN connector 591 and log processing layer 592, receives and processes the different types of operational data (e.g., noted abnormalities, deviations, issues, logs and/or performance metric data) from the CDN aggregators 580/880. The CDN connector 591 implements one or more APIs to interface with a CDN aggregator 580/880. As explained herein above, the CDN aggregators 580/880 are geographically distributed. The EM module database 594 and the CDN database 595 respectively maintain details of the edge monitoring modules 130/530/830 and the CDN aggregators 580/880.

Referring, for example, to FIGS. 4 and 6, using registration managers (e.g., registration manager 131 of the edge monitoring module 130 and registration manager 581 of CDN aggregator 580), the edge monitoring modules 130/530/830 are registered with their corresponding CDN aggregators (e.g., CDN aggregators 580/880). For example, based on the location settings of the edge monitoring modules 130/530/830 (e.g., designated by a customer), the registration managers of the edge monitoring modules 130/530/830 identify CDN aggregators 580/880 that are in proximity to (e.g., within a same area or region as) as the edge monitoring modules 130/530/830. In other words, an edge monitoring module 130/530/830 identifies the edge platform where the edge monitoring module 130/530/830 is located as corresponding to a CDN aggregator 580/880 based at least in part on the location of the edge platform with respect to the location of the CDN aggregator 580/880. The registration manager 131 may analyze location settings of the edge monitoring module 130/530/830 and of the CDN aggregator 580/880 to identify a local CDN aggregator 580/880. Registration data can be built-in to the edge monitoring modules 130/530/830. Once registered with a CDN aggregator 580/880, an edge monitoring module 130/530/830 is enabled to perform support process operations. For example, an edge monitoring module 130/530/830 will have an inventory of devices and applications within a datacenter and will monitor the devices and applications based on designated policies. In illustrative embodiments, communications between edge monitoring modules 130/530/830 and CDN aggregators 580/880 occurs over secure channels via, for example, EM module connectors (e.g., EM module connector 585) using the high-grade encryption and unique registered identifiers for each edge monitoring module 130/530/830.

The bi-directional proxy layer 132 filters incoming and outgoing requests and responses based on rules for different directions of data traffic (e.g., forward (outgoing) and reverse (incoming) proxy rules). The rules can be designated in response to operations performed by the edge monitoring modules 130/530/830 to determine request sources that are performing reconnaissance activities. For example, the bi-directional proxy layer 132 stores different types of lists (e.g., a list of restricted/unauthorized sources and a list of unrestricted/authorized sources) to filter out unwanted requests coming from the network 104. Datacenter owners may have the option to add extra parameters to these lists for additional validation based on stored values. Upon identification of a source (e.g., requesting device 102) that is found to be a cyber attacker and/or performing reconnaissance activity, data corresponding to that source will automatically be added to the list of restricted/unauthorized sources from which requests will be rejected and/or responses will be prohibited.

The edge monitoring modules 130/530/830 function as a hop between the firewalls 120/520 and remaining portions of a datacenter (e.g., datacenter 110 or 510). Advantageously, unlike conventional approaches, the edge monitoring modules 130/530/830 add a layer of validation and security in a datacenter (e.g., datacenter 110 or 510) to invalidate and reject different malicious requests with an active thread monitoring methodology. The threats that are created by the incoming requests may be to systems and components such as, but not necessarily limited to, DNSs, DHCP systems, proxies, ports, firewalls, SMTP systems, active directories, domain controllers, etc.

As explained in more detail herein, when a request for services is received at a datacenter (e.g., datacenter 110 or 510), the monitoring layer 133 will create (e.g., spawn) an active thread and assign the thread to the request to monitor different transmission paths (e.g., flows) generated in response to the request. If the learning layer 134 identifies any deviations from normal request processing patterns (e.g., baselines) in the flows, the learning layer 134 will designate the request as reconnaissance and terminate processing to respond to the request. The logger 136 will log full activity details from request receipt until termination (or output of a response in the event of a non-malicious request). The logger 136 is configured to log different types of regular network transactions and suspicious reconnaissance activities captured in a datacenter. The logger 136 transmits the log to the backend server 590/890 through, for example, the log processing layer 582 of a CDN aggregator 580 and a log processing layer 592 of a backend server 590. As explained in more detail herein, the backend learning layer 596 of the backend server 590 uses machine learning to perform predictive analysis and self-learning of patterns of normal and reconnaissance activities.

In order to validate and identify different types or requests (e.g., malicious and non-malicious requests), a database of an edge monitoring module 130/530/830 (e.g., database 137) stores multiple types of data such as, for example, default and user-configured rules and parameters for the bi-directional proxy layer 132, monitoring policies for identification of reconnaissance activities, lists of accepted and suspicious values and flags to look for in incoming data packets, lists of suspicious activities and calls previously identified as reconnaissance, a restricted/unauthorized list for blocked sources identified as malicious, details of critical applications and services being monitored, acceptable (e.g., normal) flows/sequences of operations, lists of expected and acceptable data items in an outgoing response, details of CDN aggregator connectivity and uploaded logs and inventory data. In addition, the logged information and other data from the components of the edge monitoring modules 130/530/830 is stored in the database 137. The database 137 stores data related to, for example, web services, application services, database services, proxy rules, protocol handling mechanisms, and accepted and rejected requests.

In some embodiments, the database 137 includes, but is not necessarily limited to, proxy rules, APIs to protect, APIs to block, approved machines, blocked IP patterns, completed requests, rejected requests and requests in progress. As can be understood, the logged information such as, for example, open protocol connections, completed requests, rejected requests and requests in progress can be updated periodically and/or at designated intervals to reflect real-time information. As can be understood, the database 137 includes rules, conditions and/or links (e.g., proxy rules, APIs to protect, APIs to block, approved machines and blocked IP patterns) under which the bi-directional proxy layer 132 and/or other components of the edge monitoring modules 130/530/830 operate.

A learning layer of an edge monitoring module 130/530/830 (e.g., learning layer 134) and/or a backend learning layer of a backend server 590/890 (e.g., backend learning layer 596) trained in a training phase based on historical data including internal enterprise data, previous requests, previous processing data and previous request responses. As a result of the training phase, standard (e.g., normal/baseline/non-malicious) requests, processing flows and responses will be identified. The learning layers will identify standard paths for applications and web requests, including traversals through different internal services. As a result, the learning layers will identify normal behavior patterns so that deviations and/or abnormalities from the normal behavior patterns can be identified and designated as reconnaissance activity.

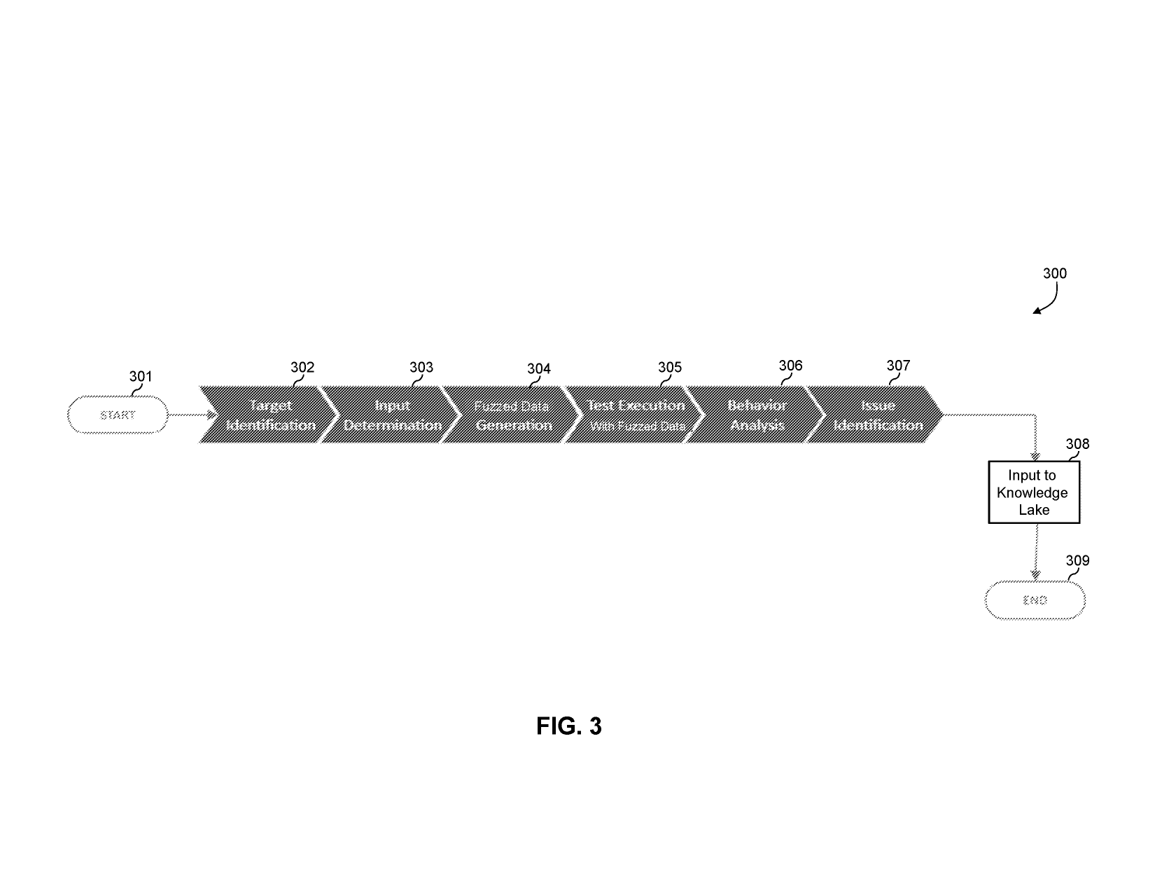

Referring to the operational flow 300 in FIG. 3, the learning layers (e.g., learning layer 134 and/or backend learning layer 596) utilize a fuzz testing mechanism to generate multiple random outputs for different application sets and families of applications. Fuzz Testing uses invalid, unexpected and/or random data as input and then checks for exceptions to identify issues. Fuzz testing is an automated testing technique that uses the invalid, unexpected and/or random data as inputs to identify potential security vulnerabilities. Fuzz testing identifies issues that can be exploited by an attacker, such as, but not necessarily limited to, buffer overflows, SQL injections, or other types of input-validation issues.

Following a start (step 301) of the operational flow 300, at step 302, target identification is performed, where the target system or the software application to be tested is designated. Then, at step 303, random inputs for testing are determined. At step 304, fuzzed data is generated, where the random inputs are converted into fuzzed data, which are the random inputs in the form of fuzzy logic. At step 305, testing is executed with the fuzzed data. For example, operations in response to the random inputs (e.g., fuzzed data). At step 306, the system behavior is analyzed after the execution to determine if any exceptions (e.g., abnormalities) have occurred. Then, at step 307, issues and other defects are identified based on the analysis. In illustrative embodiments, at step 308, the identified issues are input to a knowledge lake (e.g., knowledge lake 597) and the process ends at step 309. The identified issues from the knowledge lake are sent to the edge monitoring modules 130/530/830 and used by the corresponding learning layer (e.g., learning layer 134) in connection with identifying system abnormalities when problematic or malicious requests are received. The results of the machine learning analysis stored in the knowledge lake 597 are used by the policy manager 593 to generate updated policies for processing of requests by the edge monitoring modules 130/530/830. These policies will be generated by the policy manager 593 at the backend server 590/890 and passed through the policy managers 583 of the CDN aggregators 580/880 to the edge monitoring modules 130/530/830.

Fuzz testing generates several inputs/testing behaviors which can be missed as part of normal validation. Fuzz testing identifies different observations and patterns of use for applications to be stored in the knowledge lake. If similar behavior is identified during analysis of requests and subsequent processes by the edge monitoring modules 130/530/830, the learning layer can identify whether the requests correspond malicious (e.g., reconnaissance) activity or non-malicious activity.

In accordance with illustrative embodiments, when a network (e.g., web) request reaches a datacenter (e.g., datacenter 110/510) and is processed by a firewall (e.g., firewall 120/520), the edge monitoring module 130/530/830 intercepts the request and verifies the source against a list of known malicious actors. The edge monitoring module 130/530/830 also performs checks for signs of reconnaissance activity, which may include checking for features related to DDoS and flooding attacks and checking the structural integrity of request data along with different flags in incoming data packets. The edge monitoring module 130/530/830 is configured to trigger a thread to track processes performed in response to the requests, which can include, for example, monitoring transmission paths and flows of data in connection with processing the request.

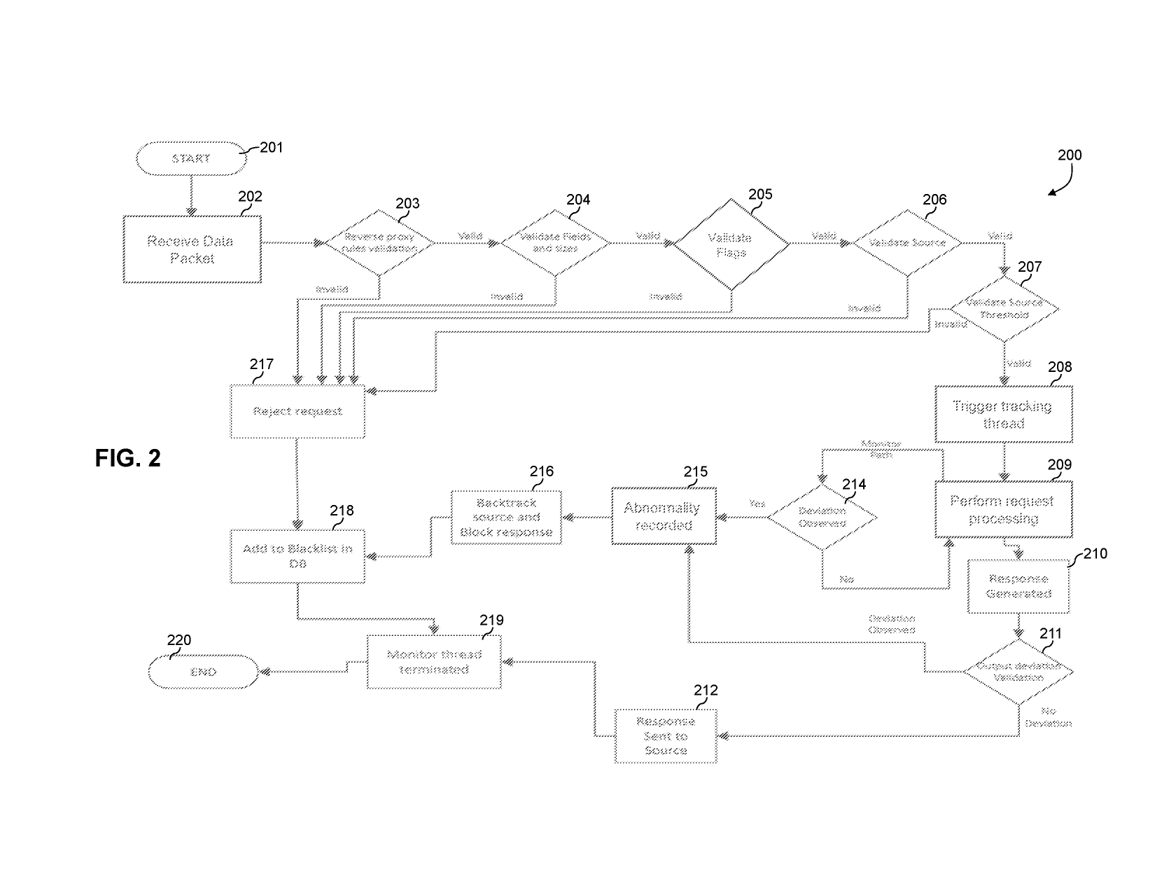

In more detail, referring to the operational flow 200 for validation of network requests and of request processing in FIG. 2, at a start 201 of the operational flow 200, a data packet is received (receive data packet) at step 202. Then at step 203, reverse proxy rules validation is performed. If the data packet is found to be valid following reverse proxy rules validation, then header fields and their sizes are validated at step 204 (validate fields and sizes). If the data packet is found to be valid following validation of header fields and their sizes, then at step 205 flags are validated (validate flags). If the data packet is found to be valid following validation of flags, then at step 206 a source of the data packet is validated (validate source). If the data packet is found to be valid following validation of the source, then at step 207, a determination is made whether the data packet originates from the same source as other data packets and whether a number of data packets from the same source exceeds a designated threshold (validate source threshold). If the data packet is found to be invalid at any of steps 203-207, then the request is rejected at step 217 (reject request).

If the data packet is found to be valid following validation of the source threshold, then at step 208, a thread is triggered (trigger tracking thread) to track processes performed in response to the requests, which can include, for example, monitoring transmission paths and flows of data in connection with processing the request. Then at step 209, request processing is performed, and at step 210, a response to the request is generated. The request processing and response generation can be performed by, for example, an application or web service of the datacenter 110/510.

In tracking the processes performed in response to the requests, at step 214, if a deviation in the processing in the processing is observed by the edge monitoring module 130/530/830, the abnormality is recorded at step 215 by the edge monitoring module 130/530/830 in the database 137 and/or knowledge lake 597. At step 216, following identification of the abnormality, backtracking logic (e.g., backtracking logic 135) of the edge monitoring module 130/530/830 backtracks movement of the request back to a source (e.g., requesting device 102) of the request. The backtracking logic identifies the source, including source details (e.g., source IP address, port, name, etc.) as a restricted/unauthorized source, and the bi-directional proxy layer 132 blocks responses to requests from the identified source from being transmitted/outputted from the datacenter 110/510. At step 218 the identified source is added to a list of restricted/unauthorized sources from which requests are not to be processed and responses are not to be generated. The calls/requests from such sources will be ignored in the future and no new threads will be created for such malicious calls, thereby saving system resources. Following addition of the source to the list of restricted/unauthorized sources, the created tracking/monitor thread is terminated at step 219, and the process ends at step 220.

In an alternative path, if a deviation in the processing in the processing is not observed by the edge monitoring module 130/530/830 at step 214, request processing continues at step 209, and the response to the request is generated at step 210. At step 211, a determination is made whether the response deviates from a normal response to a non-malicious request (output deviation validation). If a deviation is observed at step 211, the process follows to step 215, where the abnormality is recorded and continues to steps 216, 218, 219 and 220 as described herein above. If no deviation is observed at step 211, it is concluded that the request was normal, and the bi-directional proxy layer 132 allows a response to be transmitted to the source at step 212. Following that, the created tracking/monitor thread is terminated at step 219, and the process ends at step 220.

Regarding the operational flow 200, in connection with steps 203-207, received data packets and their headers are scanned and validated for structural abnormalities. For example, the edge monitoring module 130/530/830 verifies different flags and header fields. Header fields can comprise, for example, source port and destination port data (e.g., IP address, port). The received data packet may also set flags, where 0 for a flag in a header indicates that the flag has not been set, and 1 in a header indicates that the flag has been set. The edge monitoring module 130/530/830 verifies whether the flags are properly set based on the circumstances or the type of data or service corresponding to a request. In some cases, the edge monitoring module 130/530/830 may determine that the setting of a flag or lack thereof is not logically appropriate for a given set of circumstances. For example, the edge monitoring module 130/530/830 is configured to detect urgent [URG] and other flags that are improperly set for certain types of data or requests. The edge monitoring module 130/530/830 may rely on rules or other information stored in the database 137 regarding the propriety of certain flags for designated data types and/or requests.

The edge monitoring module 130/530/830 verifies reserved header fields, whether the sizes of different header fields are within a designated range, and whether the size of the header is within a designated range. With regard to step 207, a determination is made as to whether a data packet originates from the same source as other data packets and whether a number of data packets from the same source exceeds a designated threshold. In a non-limiting operational example, the edge monitoring module 130/530/830 validates protocol requests for signs of flooding, and blocks multiple SYN requests (SYN flooding) from the same IP address based on stored values of SYN requests from the same IP address in the database 137. In order to avoid situations where more than one SYN request may be needed (e.g., the same client sends a second SYN request if it fails to receive a response for the first SYN request), the edge monitoring module 130/530/830 will have a designated threshold number of SYN requests from the same IP address to determine whether a flooding attack is being perpetrated and the SYN requests should be rejected.

The triggering of the tracking thread at step 208 enables tracking of a request sent to the datacenter 110/510, and activity to process and respond to the request. Based on the tracking of movement of thread, the backtracking logic can identify the source of the request. If the learning layer (e.g., learning layer 134) designates a request as reconnaissance activity (e.g., observed deviation from normal patterns), the backtracking logic identifies the request source and source details. Once a request is marked as reconnaissance activity, the bi-directional proxy layer 132 blocks the outgoing response related to the request.

The edge monitoring module 130/530/830 captures the deviations and abnormalities corresponding to a request in the database 137, which can be transmitted to the backend server 590/890 via a CDN aggregator 580/880, and added to the knowledge lake 597. In illustrative embodiments, the backtracking logic (e.g., backtracking logic 135) queries the firewall 120/520 and other services to retrieve additional details on the sources and this data can also be sent to the backend server 590/890 via a CDN aggregator 580/880, and added to the knowledge lake 597, so that the data could be used by other edge monitoring modules 130/530/830.

Once the backtracking is complete and the data is saved in the database 137, or request processing is completed, the thread will be terminated to save system resources. For example, if no abnormalities or deviations are detected via the monitoring thread, a response to the request is generated. Then, the edge monitoring module 130/530/830 captures the response data in the bi-directional proxy layer 132 and validates the output to verify that there is no deviation from acceptable data items or types in the outgoing response. In this case, the response is sent to the source since reconnaissance activity has not been detected, and the tracking thread is terminated.

Alternatively, if abnormalities or deviations are detected via the monitoring thread (e.g., deviations from normal paths/flows), a response is prevented from being generated, the source is listed as restricted, and the thread is terminated. In another scenario, if a response is generated, the edge monitoring module 130/530/830 captures the response data in the bi-directional proxy layer 132 and determines that the response includes deviation(s) from acceptable data items or types in the outgoing response. In this case, the bi-directional proxy layer 132 blocks the response from being sent, and the tracking thread is terminated.

Through, for example, the registration managers 131 and 581, the CDN aggregators 580/880 provide registration support to the edge monitoring modules 130/530/830 in a given region and send the details to the backend server 590/890. Based on the data provided via the CDN aggregator 580/880, the backend server 590/890 identifies edge monitoring modules 130/530/830 and performs smart analysis on inputted operational data (e.g., periodic logs with reconnaissance capture information). The CDN aggregators 580/880 monitor and facilitate the security monitoring activities happening over a network by the edge monitoring modules 130/530/830. The CDN aggregators 580/880 collect and upload periodic logs along with hardware and application inventory data from edge monitoring modules 130/530/830 to the backend server 590/890.

Through, for example, the policy manager 593, the backend server 590/890 updates the policies and patterns to be used for monitoring of network requests directed toward applications and services in a datacenter 110/510. The policies are passed to the respective edge monitoring modules 130/530/830 via the policy managers 583 of the CDN aggregators 580/880. The backend server 590/890 is a centrally located service which monitors all the security filter and monitoring activities happening over a large region (e.g., the world) with the help of CDN aggregators 580/880. The backend server 590/890, through the CDN aggregators 580/880, collects data from all edge monitoring modules 130/530/830 which are deployed in a geographically distributed manner. The backend server 590/890 maintains the details of all the CDN aggregators 580/880 and edge monitoring modules 130/530/830 in the EM module database 594 and CDN database 595. The backend server 590/890 further maintains the monitoring policies to capture the reconnaissance activities in the policy manager 593 and knowledge lake 597. The log processing layer 592 of the backend server 590/890 accepts uploads of periodic logs and hardware and application inventory from edge monitoring modules 130/530/830 via respective CDN aggregators 580/880. This data is utilized to perform smart analysis of security and reconnaissance activities happening in datacenters 110/510.

Based on the application and hardware inventory, each reconnaissance activity is mapped to different families and versions of hardware and applications to facilitate identification of patterns and/or trends of reconnaissance and attack activity happening against different families and versions of hardware and applications. The monitoring policies are updated to different edge monitoring modules 130/530/830 based on the mapping. The backend learning layer 596 identifies missed reconnaissance activity from periodic application logs received from edge monitoring modules 130/530/830 and updates the respective monitoring policies based on the identified missed reconnaissance activity.

According to one or more embodiments, the database 137, database 584, EM module database 594, CDN database 595, knowledge lake 597 and other data repositories or databases referred to herein can be configured according to a relational database management system (RDBMS) (e.g., PostgreSQL). In some embodiments, the database 137 and other data repositories or databases referred to herein are implemented using one or more storage systems or devices associated with the datacenter 110. In some embodiments, one or more of the storage systems utilized to implement the database 137, database 584, EM module database 594, CDN database 595, knowledge lake 597 and other data repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The firewall 120, edge monitoring module 130, network switch 140, infrastructure 150 and one or more elements thereof in the FIG. 1 embodiment are each assumed to be implemented using at least one processing device. Each such processing device generally comprises at least one processor and an associated memory, and implements one or more functional modules for controlling certain features of firewall 120, edge monitoring module 130, network switch 140, infrastructure 150 and one or more elements thereof.

At least portions of the firewall 120, edge monitoring module 130, network switch 140, infrastructure 150 and one or more elements thereof may be implemented at least in part in the form of software that is stored in memory and executed by a processor. The firewall 120, edge monitoring module 130, network switch 140, infrastructure 150 and one or more elements thereof comprise further hardware and software required for running the datacenter 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

It is assumed that the datacenter 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the firewall 120, edge monitoring module 130, network switch 140, infrastructure 150 and one or more elements thereof can each be implemented in the form of one or more LXCs running on one or more VMs. Other arrangements of one or more processing devices of a processing platform can be used to implement the firewall 120, edge monitoring module 130, network switch 140, infrastructure 150 and one or more elements thereof. Other portions of the system 100 can similarly be implemented using one or more processing devices of at least one processing platform.

It is to be appreciated that these and other features of illustrative embodiments are presented by way of example only, and should not be construed as limiting in any way. Accordingly, different numbers, types and arrangements of system elements such as the firewall 120, edge monitoring module 130, network switch 140, infrastructure 150 and one or more elements thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the datacenter 110 can be offered to cloud infrastructure customers or other users as part of FaaS, CaaS and/or PaaS offerings.

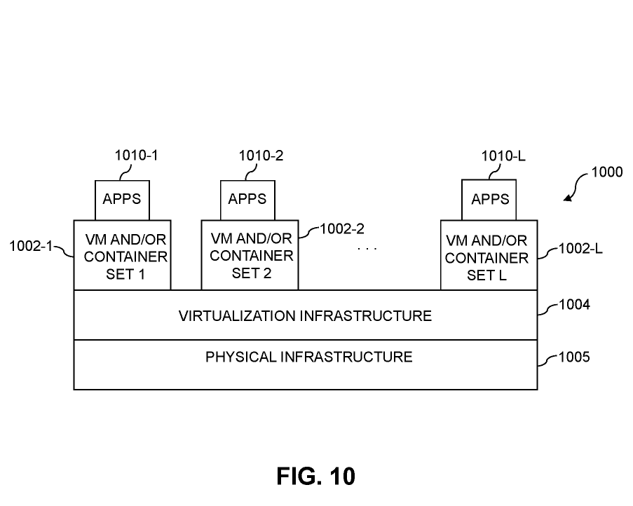

The operation of the information processing system 100 will now be described in further detail with reference to the flow diagram of FIG. 9. With reference to FIG. 9, a process 900 for detection and prevention of cyber attack reconnaissance as shown includes steps 902 through 906, and is suitable for use in the system 100 but is more generally applicable to other types of information processing systems comprising a datacenter including an edge monitoring module configured for detecting and preventing cyber attack reconnaissance in a datacenter.

In step 902, one or more requests for data are received over at least one computer network. In illustrative embodiments, receiving the one or more requests comprises intercepting transmission of the one or more requests from a firewall.

In step 904, at least one of the one or more requests and one or more processes performed in response to the one or more requests are analyzed to determine whether the one or more requests comprise reconnaissance for a cyber attack. In illustrative embodiments, the analyzing comprises identifying a source of the one or more requests, determining whether the identified source has been designated for restriction, and determining that the one or more requests comprise the reconnaissance for the cyber attack in response to determining that the identified source has been designated for restriction. In illustrative embodiments, the analyzing comprises scanning the one or more requests to validate one or more elements corresponding to the one or more requests, and the one or more elements comprise at least one of one or more header fields and one or more flags.

In step 906, at least one of generation and transmission of one or more responses to the one or more requests is prevented in response to determining that the one or more requests comprise the reconnaissance for the cyber attack.

The process may further comprise triggering a thread to track one or more transmission paths of at least one of the one or more requests and the one or more processes. The analyzing may comprise scanning the one or more transmission paths to identify one or more deviations from a standard transmission path for the one or more requests, and determining that the one or more requests comprise the reconnaissance for the cyber attack in response to identifying the one or more deviations from the standard transmission path. In illustrative embodiments, the standard transmission path is determined using one or more machine learning algorithms implementing a fuzz testing mechanism.

The process may further comprise backtracking through the one or more transmission paths to identify one or more details corresponding to a source of the one or more requests determined to comprise the reconnaissance for the cyber attack, and storing the one or more details corresponding to the source in one or more databases. In illustrative embodiments, the thread is terminated in response to at least one of the identifying of the one or more details and storing the one or more details. The process may further comprise preventing processing of one or more subsequent requests from the source.

The preventing of the transmission of the one or more responses may comprise using a bi-directional proxy layer to filter the one or more responses. In illustrative embodiments, the one or more processes comprise the generation of the one or more responses to the one or more requests, and the analyzing comprises identifying one or more deviations in the one or more responses from a standard response to the one or more requests, and determining that the one or more requests comprise the reconnaissance for the cyber attack in response to identifying the one or more deviations from the standard response. The standard response can be determined using one or more machine learning algorithms implementing a fuzz testing mechanism.

In illustrative embodiments, the process is performed by a processing device operatively coupled to a memory. The processing device comprises an edge device located at a same location as one or more servers hosting at least one application configured to respond to the one or more requests. The edge device is connected to a content delivery network aggregator and to a backend server through the content delivery network aggregator.

It is to be appreciated that the FIG. 9 process and other features and functionality described above can be adapted for use with other types of information systems configured to detect and prevent cyber attack reconnaissance in a datacenter or other type of platform.

The particular processing operations and other system functionality described in conjunction with the flow diagram of FIG. 9 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 9 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with the edge monitoring module 130/530/830 as disclosed herein can provide a number of significant advantages relative to conventional arrangements. For example, the edge monitoring modules 130/530/830 are disposed in datacenters to function as a hop between a firewall and a datacenter infrastructure. As a result, calls coming from the Internet will pass through the edge monitoring modules 130/530/830, adding an extra layer of validation and security.

Advantageously, when a request is received at a datacenter, an active thread will be spawned and assigned by an edge monitoring module 130/530/830 to the request so that different flows corresponding to the request can be monitored. If there is any suspicious activity in a flow, the request will be identified as reconnaissance, processing to respond to the request will be terminated, and full activity details will be logged. As an additional advantage, logged details are sent to backend servers for predictive analysis and self-learning.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the datacenter 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a datacenter in illustrative embodiments. These and other cloud-based systems in illustrative embodiments can include object stores.

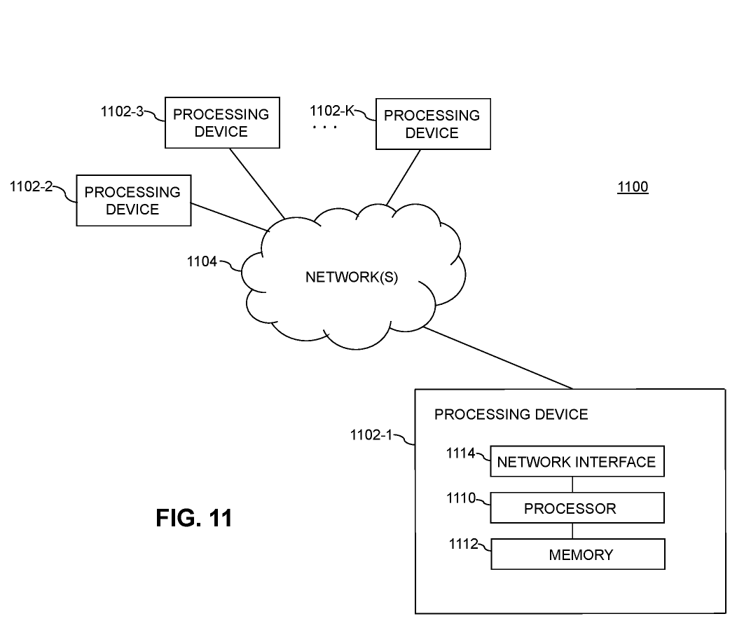

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112. The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the datacenter 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and datacenters. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving one or more requests for data, wherein the one or more requests are received over at least one computer network;
analyzing at least one of the one or more requests and one or more processes performed in response to the one or more requests to determine whether the one or more requests comprise reconnaissance for a cyber attack; and
preventing at least one of generation and transmission of one or more responses to the one or more requests in response to determining that the one or more requests comprise the reconnaissance for the cyber attack;
wherein the steps of the method are executed by a processing device operatively coupled to a memory.

2. The method of claim 1 wherein the analyzing comprises:
identifying a source of the one or more requests;
determining whether the identified source has been designated for restriction; and
determining that the one or more requests comprise the reconnaissance for the cyber attack in response to determining that the identified source has been designated for restriction.

3. The method of claim 1 wherein:
the analyzing comprises scanning the one or more requests to validate one or more elements corresponding to the one or more requests; and
the one or more elements comprise at least one of one or more header fields and one or more flags.

4. The method of claim 1 wherein receiving the one or more requests comprises intercepting transmission of the one or more requests from a firewall.

5. The method of claim 1 further comprising triggering a thread to track one or more transmission paths of at least one of the one or more requests and the one or more processes.

6. The method of claim 5 wherein the analyzing comprises:
scanning the one or more transmission paths to identify one or more deviations from a standard transmission path for the one or more requests; and
determining that the one or more requests comprise the reconnaissance for the cyber attack in response to identifying the one or more deviations from the standard transmission path.

7. The method of claim 6 wherein the standard transmission path is determined using one or more machine learning algorithms implementing a fuzz testing mechanism.

8. The method of claim 5 further comprising:
backtracking through the one or more transmission paths to identify one or more details corresponding to a source of the one or more requests determined to comprise the reconnaissance for the cyber attack; and
storing the one or more details corresponding to the source in one or more databases.

9. The method of claim 8 further comprising terminating the thread in response to at least one of the identifying of the one or more details and storing the one or more details.

10. The method of claim 8 further comprising preventing processing of one or more subsequent requests from the source.

11. The method of claim 1 wherein the preventing of the transmission of the one or more responses comprises using a bi-directional proxy layer to filter the one or more responses.

12. The method of claim 1 wherein:
the one or more processes comprise the generation of the one or more responses to the one or more requests: and
the analyzing comprises:
identifying one or more deviations in the one or more responses from a standard response to the one or more requests; and
determining that the one or more requests comprise the reconnaissance for the cyber attack in response to identifying the one or more deviations from the standard response.

13. The method of claim 12 wherein the standard response is determined using one or more machine learning algorithms implementing a fuzz testing mechanism.

14. The method of claim 1 wherein:
the processing device comprises an edge device located at a same location as one or more servers hosting at least one application configured to respond to the one or more requests; and
the edge device is connected to a content delivery network aggregator and to a backend server through the content delivery network aggregator.

15. An apparatus comprising:
a processing device operatively coupled to a memory and configured:
to receive one or more requests for data, wherein the one or more requests are received over at least one computer network;
to analyze at least one of the one or more requests and one or more processes performed in response to the one or more requests to determine whether the one or more requests comprise reconnaissance for a cyber attack; and
to prevent at least one of generation and transmission of one or more responses to the one or more requests in response to determining that the one or more requests comprise the reconnaissance for the cyber attack.

16. The apparatus of claim 15 wherein the processing device is further configured to trigger a thread to track one or more transmission paths of at least one of the one or more requests and the one or more processes.

17. The apparatus of claim 16 wherein the analyzing comprises:
scanning the one or more transmission paths to identify one or more deviations from a standard transmission path for the one or more requests; and
determining that the one or more requests comprise the reconnaissance for the cyber attack in response to identifying the one or more deviations from the standard transmission path.

18. An article of manufacture comprising a non-transitory processor-readable storage medium having stored therein program code of one or more software programs, wherein the program code when executed by at least one processing device causes said at least one processing device to perform the steps of:
receiving one or more requests for data, wherein the one or more requests are received over at least one computer network;
analyzing at least one of the one or more requests and one or more processes performed in response to the one or more requests to determine whether the one or more requests comprise reconnaissance for a cyber attack; and
preventing at least one of generation and transmission of one or more responses to the one or more requests in response to determining that the one or more requests comprise the reconnaissance for the cyber attack.

19. The article of manufacture of claim 18 wherein the program code further causes said at least one processing device to perform the step of triggering a thread to track one or more transmission paths of at least one of the one or more requests and the one or more processes.

20. The article of manufacture of claim 18 wherein the analyzing comprises:
scanning the one or more transmission paths to identify one or more deviations from a standard transmission path for the one or more requests; and
determining that the one or more requests comprise the reconnaissance for the cyber attack in response to identifying the one or more deviations from the standard transmission path.
